(19) United States
(12) Patent Application Publication
(10) Pub. No.: US 2022/0048591 A1
(43) Pub. Date: Feb. 17, 2022

(54) BICYCLE BRAKE LEVER

(71) Applicant: TEKTRO TECHNOLOGY CORPORATION, Changhua County (TW)

(72) Inventor: Chia-Wen HSIEH, Changhua County (TW)

(73) Assignee: TEKTRO TECHNOLOGY CORPORATION, Changhua County (TW)

(21) Appl. No.: 17/398,325

(22) Filed: Aug. 10, 2021

(30) Foreign Application Priority Data
Aug. 12, 2020 (TW) 109127293

(51) Int. Cl. B62L 3/02

(52) U.S. Cl. CPC B62L 3/023

(57) ABSTRACT

A bicycle brake lever includes a casing, a hydraulic assembly, and a driving assembly. The hydraulic assembly is disposed in the casing. The hydraulic assembly includes a main body, a piston located in the main body, and a link connected to the piston. The driving assembly includes a pivotable component and a lever. The pivotable component has a mount portion, a first end portion, and a second end portion. The mount portion is connected to the first end portion and the second end portion and pivotably disposed on the main body. The first end portion is pivotably disposed on the link. The lever is pivotably disposed on the main body, and the second end portion is pivotably disposed on the lever. When the lever is pivoted, the lever moves the piston via the pivotable component and the link so as to increase an oil pressure in the main body.

### CROSS-REFERENCE TO RELATED APPLICATIONS

This non-provisional application claims priority under 35 U.S.C. § 119(a) on Patent Application No(s). 109127293 filed in Taiwan, R.O.C. on Aug. 12, 2020, the entire contents of which are hereby incorporated by reference.

### TECHNICAL FIELD

The disclosure relates to a brake lever, more particularly to a bicycle brake lever.

### BACKGROUND

In recent years, road bikes, mountain bikes and other types of bicycles are all popular in the market, and it motivates bicycle manufacturers to pay more attention on improving their products.

In general, a bicycle brake lever is in a push type. The so-called push-type brake lever is that a part of a link is pivotably connected to a lever is located below a pivoting axis of the lever, and pivoting the lever can push a piston in a hydraulic chamber towards the bottom of the hydraulic chamber via the link so as to increase oil pressure inside the hydraulic chamber. However, since the part of the link is pivotably connected to the lever is located below the pivoting axis of the lever, the lever may pinch fingers while pushing the lever. Therefore, how to solve the aforementioned problem is one of the crucial topics in this field.

### SUMMARY

The disclosure provides a bicycle brake lever capable of preventing pinching fingers.

One embodiment of the disclosure provides a bicycle brake lever. The bicycle brake lever is adapted to be mounted on a handlebar. The bicycle brake lever includes a casing, a hydraulic assembly, and a driving assembly. The hydraulic assembly is disposed in the casing. The hydraulic assembly includes a main body, a piston, and a link, the piston is movably located in the main body, and the link is connected to the piston. The driving assembly includes a pivotable component and a lever. The pivotable component has a mount portion, a first end portion, and a second end portion. The mount portion is located between and connected to the first end portion and the second end portion, the mount portion is pivotably disposed on the main body, and the first end portion of the pivotable component is pivotably disposed on the link. The lever is pivotably disposed on the main body, and the second end portion of the pivotable component is pivotably disposed on the lever. When the lever is pivoted relative to the main body, the lever moves the piston via the pivotable component and the link so as to increase an oil pressure in the main body.

Another embodiment of the disclosure provides a bicycle brake lever. The bicycle brake lever is adapted to be mounted on a handlebar. The bicycle brake lever includes a casing, a hydraulic assembly, a driving assembly, an elastic component, an adjustment component. The hydraulic assembly is disposed in the casing. The driving assembly is configured to drive the hydraulic assembly. The driving assembly includes a lever, the lever includes an operating part and a transmission part, and the operating part is pivotably disposed on the transmission part. Two opposite ends of the elastic component respectively press against the operating part and the transmission part, and the elastic component is configured to force the operating part to pivot relative to the transmission part along a pivoting direction. The adjustment component is in contact with the operating part. The adjustment component is movable to force the operating part to pivot relative to the transmission part along a direction opposite to the pivoting direction to adjust the position of the operating part relative to the transmission part.

According to the bicycle brake levers as discussed in the above embodiments, the pivotable component connects the link with the lever, and the first end portion and the second end portion of the pivotable component, located opposite to each other, are respectively and pivotably disposed on the link and the lever, such that the part of the link being pivotably connected to the pivotable component is located above the part of the lever being pivotably connected to the main body while having the bicycle brake lever being a push-type brake lever. This arrangement of the bicycle brake lever prevents pinching fingers when pushing the lever.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a bicycle brake lever according to a first embodiment of the disclosure and a handlebar;

FIG. 2 is an exploded view of the bicycle brake lever and the handlebar in FIG. 1;

FIG. 3 is a cross-sectional view of the bicycle brake lever and the handlebar in FIG. 1;

FIG. 4 is a cross-sectional view of the bicycle brake lever and the handlebar in FIG. 3 when the lever is pivoted;

FIG. 5 is a cross-sectional view of the bicycle brake lever and the handlebar in FIG. 3 when a position of an operating part of the lever is changed;

FIGS. 6 to 12 are respectively cross-sectional views of bicycle brake levers according to other embodiments of the disclosure and handlebars.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

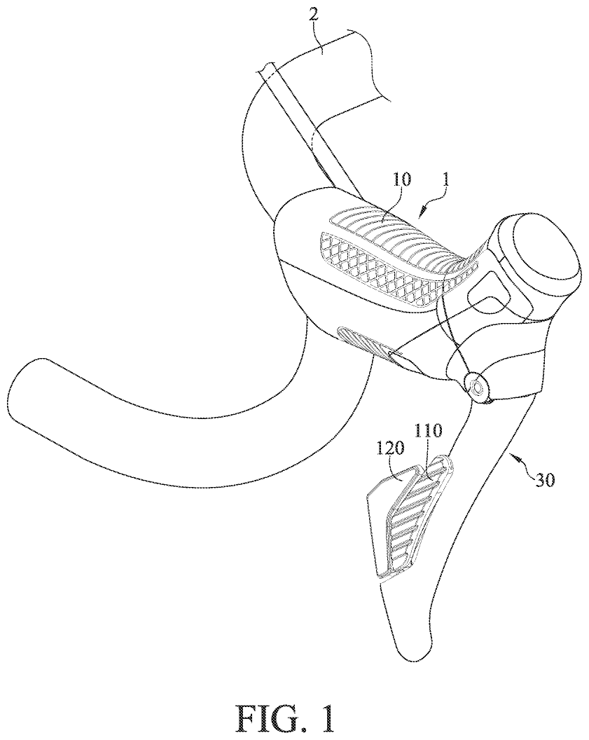

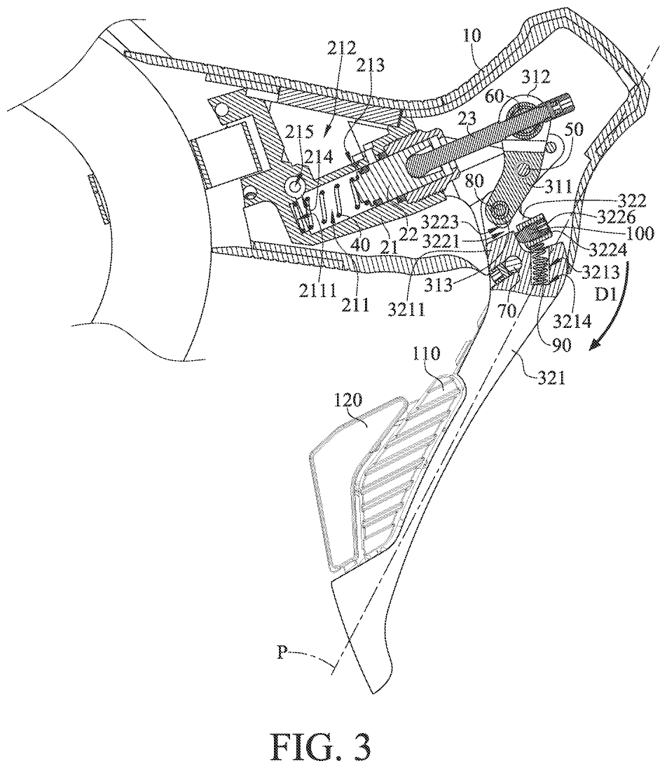

Referring to FIGS. 1 to 3, there are shown a perspective view, an exploded view, and a cross-sectional view of a bicycle brake lever 1 according to a first embodiment of the disclosure and a handlebar 2.

In this embodiment, the bicycle brake lever 1 is configured to be mounted on the handlebar 2 and includes a casing 10, a hydraulic assembly 20, and a driving assembly 30.

The hydraulic assembly 20 is disposed in the casing 10, and the hydraulic assembly 20 includes a main body 21, a piston 22, and a link 23.

The main body 21 has a hydraulic chamber 211, an oil storage space 212, an oil inlet 213, an oil outlet 214, and an oil outlet channel 215. The oil storage space 212 is in fluid communication with the hydraulic chamber 211 via the oil inlet 213, and the oil outlet 214 is in fluid communication with the hydraulic chamber 211. In this embodiment, the oil inlet 213 is located farther away from an inner bottom surface 2111 of the hydraulic chamber 211 than the oil outlet 214. The oil outlet channel 215 is located between the hydraulic chamber 211 and the oil storage space 212 and in fluid communication with the oil outlet 214. The oil outlet channel 215 is in fluid communication with, for example, a bicycle brake caliper (not shown) via a tube (not shown).

The piston 22 is movably located in the hydraulic chamber 211 of the main body 21, and one end of the link 23 is connected to the piston 22. In the embodiment, the bicycle brake lever 1 is a push-type brake lever; specifically, the piston 22 is located between the oil outlet 214 and the link 23, and the link 23 is able to push the piston 22 towards the inner bottom surface 2111 of the hydraulic chamber 211 so as to increase the oil pressure in the hydraulic chamber 211.

In the embodiment, the bicycle brake lever 1 may further include an elastic component 40 located in the hydraulic chamber 211, two opposite ends of the elastic component 40 respectively press against the piston 22 and the inner bottom surface 2111 of the hydraulic chamber 211, and the elastic component 40 is configured to force the piston 22 to move away from the inner bottom surface 2111 of the hydraulic chamber 211.

In this embodiment, the bicycle brake lever 1 may further include a first pivot 50, a second pivot 60, a third pivot 70, and a fourth pivot 80. The driving assembly 30 includes a pivotable component 31 and a lever 32.

The pivotable component 31 has a mount portion 311, a first end portion 312, and a second end portion 313, and the mount portion 311 is located between and connected to the first end portion 312 and the second end portion 313 and is pivotably disposed on the main body 21 via the first pivot 50. The first end portion 312 of the pivotable component 31 is pivotably disposed on the other end of the link 23 opposite to the piston 22 via the second pivot 60.

The lever 32 includes an operating part 321 and a transmission part 322. The operating part 321 has a protrusion 3211 located at an end thereof, and the protrusion 3211 has a mount hole 3212. The transmission part 322 has a recess 3221, two round holes 3222, and two oval holes 3223. The recess 3221 is located between the round holes 3222 and located between the oval holes 3223. The round holes 3222 are located opposite to and aligned with each other, and the oval holes 3223 are located opposite to and aligned with each other.

The protrusion 3211 of the operating part 321 is movably located in the recess 3221 of the transmission part 322. The transmission part 322 is mounted on the main body 21. The third pivot 70 is disposed through the main body 21, the round holes 3222 and the mount hole 3212 of the protrusion 3211, such that one end of the operating part 321 and one end of the transmission part 322 are together pivotably disposed on the main body 21 via the third pivot 70. The second end portion 313 of the pivotable component 31 is pivtoably disposed on the other end of the transmission part 322 via the fourth pivot 80. Specifically, the second end portion 313 of the pivotable component 31 has a mount hole 3131. The fourth pivot 80 is disposed through the oval holes 3223 and the mount hole 3131, and the fourth pivot 80 is movably located in the oval holes 3223.

Note that the quantity of the round holes 3222 and the quantity of the oval holes 3223 may be modified as required; in some other embodiments, the pivotable component may have only one round hole and only one oval hole.

In this embodiment, the first pivot 50, the second pivot 60, the third pivot 70, and the fourth pivot 80 are arranged along a line substantially parallel to a longitudinal axis P of the lever 32, and the first pivot 50 and the fourth pivot 80 are located between the second pivot 60 and the third pivot 70. Moreover, when a bicycle having the bicycle brake lever 1 and the handlebar 2 is placed on the ground, the second pivot 60 is located away from the ground than the third pivot 70; that is, the second pivot 60 is located above the third pivot 70.

In this embodiment, the bicycle brake lever 1 may further include an elastic component 90 and an adjustment component 100, the transmission part 322 may further have a protrusion 3224 and a through hole 3225, and the operating part 321 may further have a recess 3213. The elastic component 90 is partially located in the recess 3213 of the operating part 321, and two opposite ends of the elastic component 90 respectively press against the protrusion 3224 of the transmission part 322 and an inner bottom surface 3214 of the recess 3213. The elastic component 90 is configured to force the operating part 321 to pivot relative to the transmission part 322 along a pivoting direction D1. The through hole 3225 of the transmission part 322 is located at the protrusion 3224 and connected to the recess 3221. In this embodiment, the adjustment component 100, for example, has an outer thread 1001, and the transmission part 322, for example, has an inner thread 3226 in the through hole 3225 of the transmission part 322. The adjustment component 100 is screwed into and movably located in the through hole 3225, and the adjustment component 100 is in contact with the protrusion 3211 of the operating part 321.

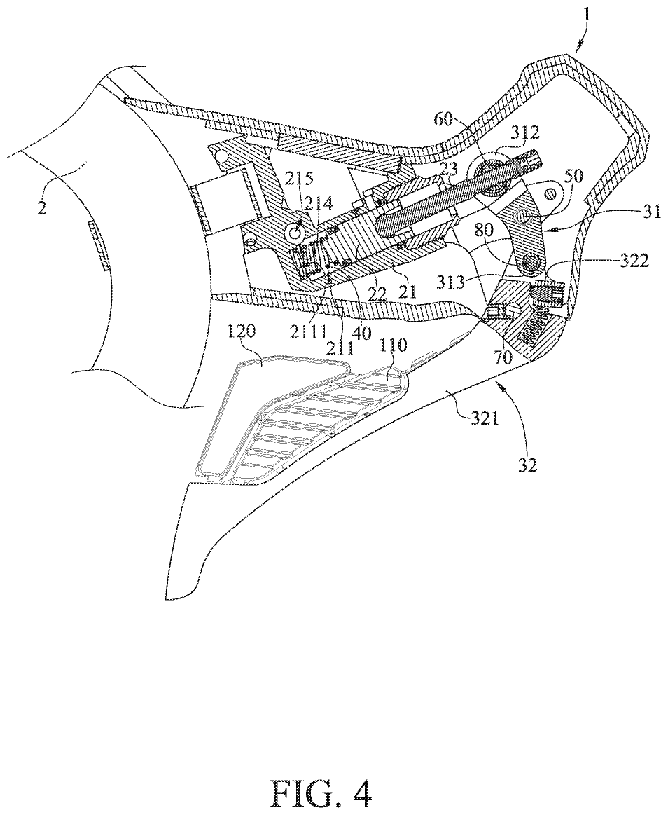

Then, the following paragraphs will introduce the operation of the bicycle brake lever 1 with reference to FIG. 4, where FIG. 4 is shown a cross-sectional view of the bicycle brake lever 1 and the handlebar 2 when the lever 32 is pivoted.

When the operating part 321 of the lever 32 is being pushed, the transmission part 322 of the lever 32 moves the second end portion 313 of the pivotable component 31 second end portion 313, such that the first end portion 312 pushes the piston 22 towards the inner bottom surface 2111 of the hydraulic chamber 211 via the link 23 so as to increase the oil pressure in the hydraulic chamber 211. This cause the oil to flow out of the main body 21 from the oil outlet 214 and the oil outlet channel 215 so as to flow into the bicycle brake caliper (now shown) via the tube (not shown), braking the bicycle.

In this embodiment, the pivotable component connects the link 23 with the lever 32, and the first end portion 312 and the second end portion 313 of the pivotable component 31, located opposite to each other, are respectively and pivotably disposed on the link 23 and the lever 32, such that the part of the link 23 being pivotably connected to the pivotable component 31 (i.e., the area adjacent to the second pivot 60) is located above the part of the lever 32 being pivotably connected to the main body 21 (i.e., the area adjacent to the third pivot 70) while having the bicycle brake lever 1 being a push-type brake lever. This arrangement of the bicycle brake lever 1 prevents pinching fingers when pushing the lever 32.

In this embodiment, when the transmission part 322 of the lever 32 moves the second end portion 313 of the pivotable component 31, the transmission part 322 of the lever 32 and the second end portion 313 of the pivotable component 31 are respectively pivoted about different axes. Therefore, the oval holes 3223 of the transmission part 322 of the lever 32 allows the fourth pivot 80 to be movable therein, ensuring that the pivotable component 31 is capable of being pivoted to the desired position.

Then, when the operating part 321 of the lever 32 is released, the elastic component 40 returns the piston 22 to its normal position so as to return the pivotable component 31 and the lever 32 back to their normal positions.

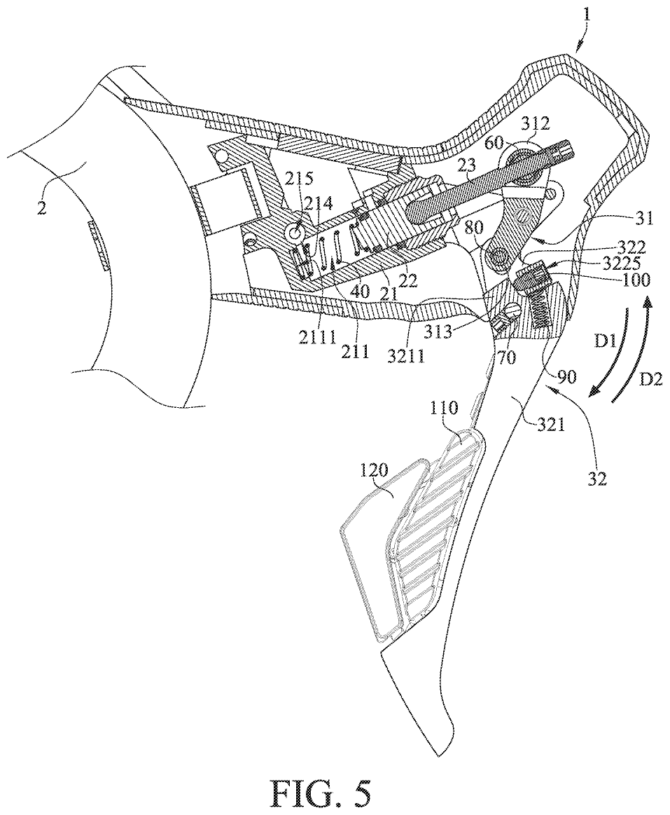

Note that the positions of both the operating part 321 of the lever 32 and the transmission part 322 may be modified. In specific, please see the following paragraphs with reference to FIG. 5, where FIG. 5 is shown a cross-sectional view of the bicycle brake lever 1 and the handlebar 2 when the position of the operating part 321 of the lever 32 is changed.

To achieve the position adjustment, the adjustment component 100 is rotated and moved further inwards the through hole 3225 of the transmission part 322. By doing so, the adjustment component 100 pushes the protrusion 3211 of the operating part 321 so as to pivot the operating part 321 relative to the transmission part 322 along a direction D2 opposite to the direction D1, thereby adjusting the position of the operating part 321 relative to the transmission part 322. On the other hand, when reversely rotating the adjustment component 100 to make it move outwards from the through hole 3225 of the transmission part 322, the elastic component 90 forces the operating part 321 to pivot relative to the transmission part 322 along the direction D1. As discussed, the position of the operating part 321 of the lever 32 can be adjusted as required.

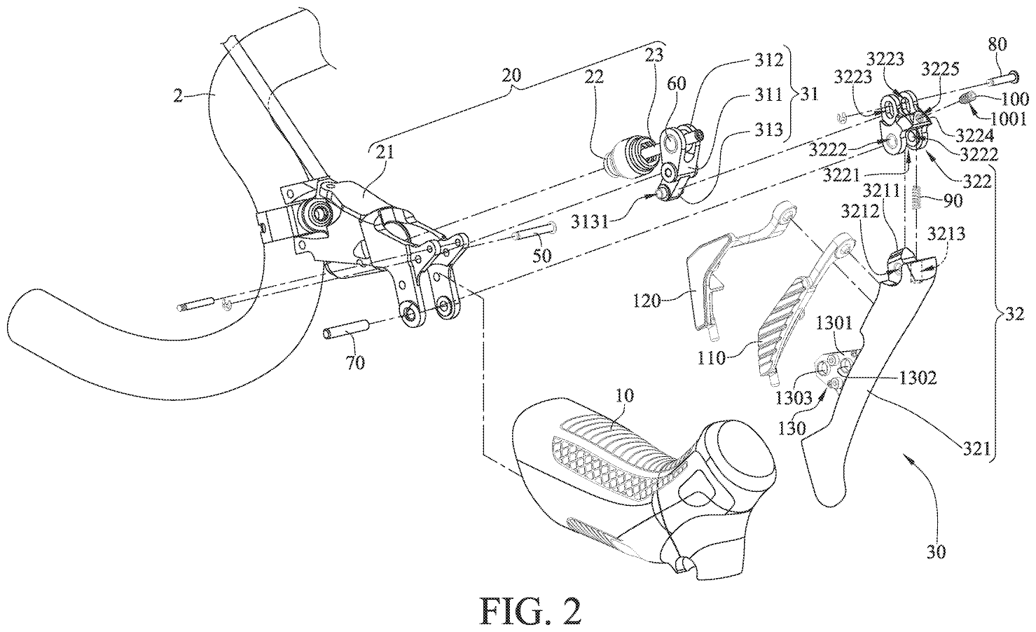

Moreover, as shown in FIGS. 1 and 2, the bicycle brake lever 1 may further include a first shift lever 110, a second shift lever 120, and a signal generator 130. The first shift lever 110 and the second shift lever 120 are pivotably disposed on the operating part 321 of the lever 32. The signal generator 130 includes a base 1301, a first switch 1302, and a second switch 1303. The base 1301 is disposed on the operating part 321 of the lever 32, and the first switch 1302 and the second switch 1303 are disposed on the base 1301. The first switch 1302 and the second switch 1303 are electrically connected to, for example, an electronic shift control box (not shown) disposed on the bicycle. The electronic shift control box and the bicycle brake lever 1 are disposed on different parts of the bicycle. The first shift lever 110 and the second shift lever 120 are respectively configured to activate the first switch 1302 and the second switch 1303. The signal generated by the first switch 1302 or the second switch 1303 may be transmitted to the electronic shift control box via a wired or wireless manner so as to instruct the electronic shift control box to operate the bicycle derailleur via a wired or wireless manner.

Then, the following paragraphs provide bicycle brake levers of other embodiments, the difference between the bicycle brake lever of each of these embodiments and the bicycle brake lever 1 of the previous embodiment shown in FIG. 1 is mainly that there is additionally a battery of the electronic shift control box disposed in or on the bicycle brake lever. Therefore, the following paragraphs will mainly introduce the position of such battery, and the structures of the other components and the relationships among them can refer to the aforementioned descriptions which are provided in accordance with FIGS. 1 to 5 and thus will not be repeatedly introduced.

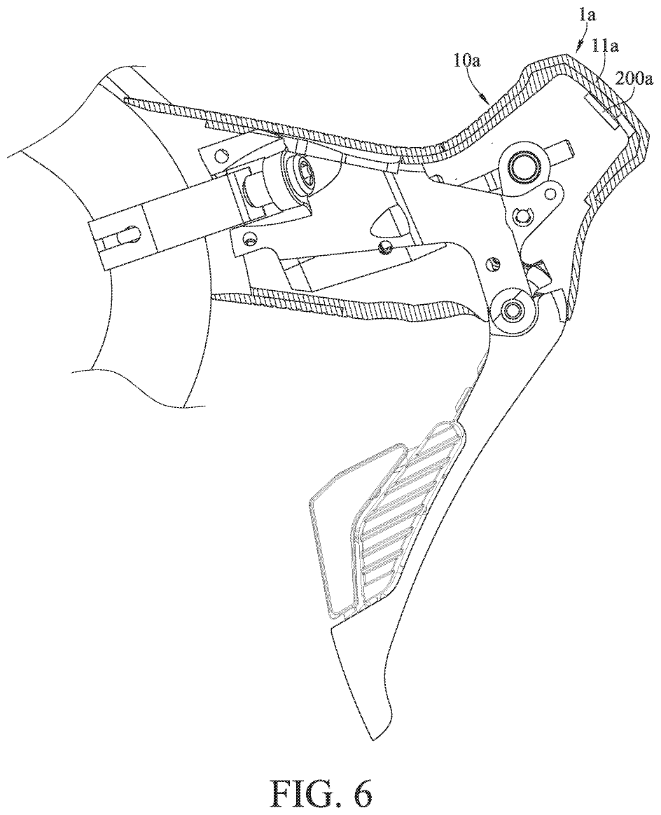

Referring to FIGS. 6 to 12, there are respectively shown cross-sectional views of bicycle brake levers according to other embodiments of the disclosure and handlebars.

As shown in FIG. 6, a casing 10a of a bicycle brake lever 1a has a ridge portion 11a. A battery 200a is disposed in the casing 10a and located aside the ridge portion 11a of the casing 10a.

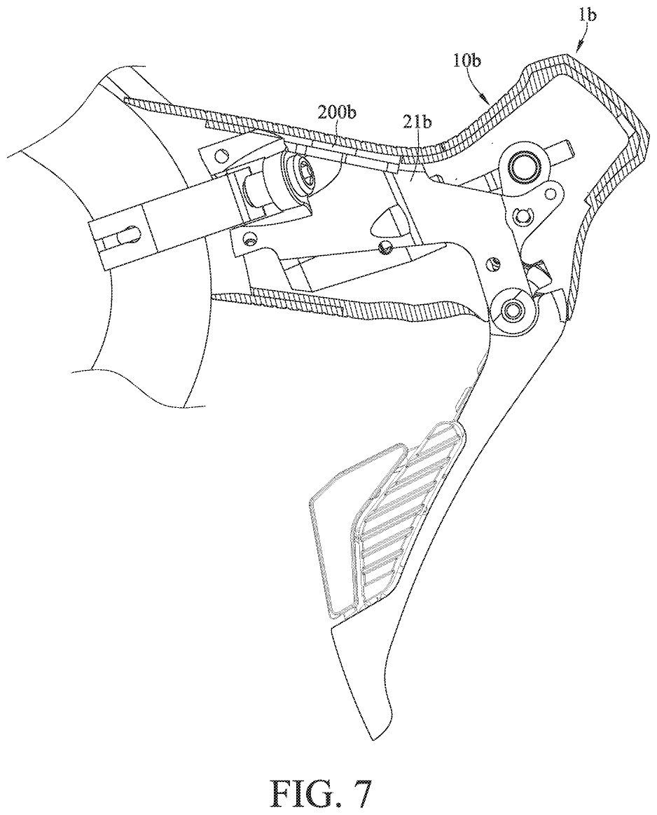

As shown in FIG. 7, a battery 200b is disposed in a casing 10b of a bicycle brake lever 1b and located above a main body 21b of the bicycle brake lever 1b.

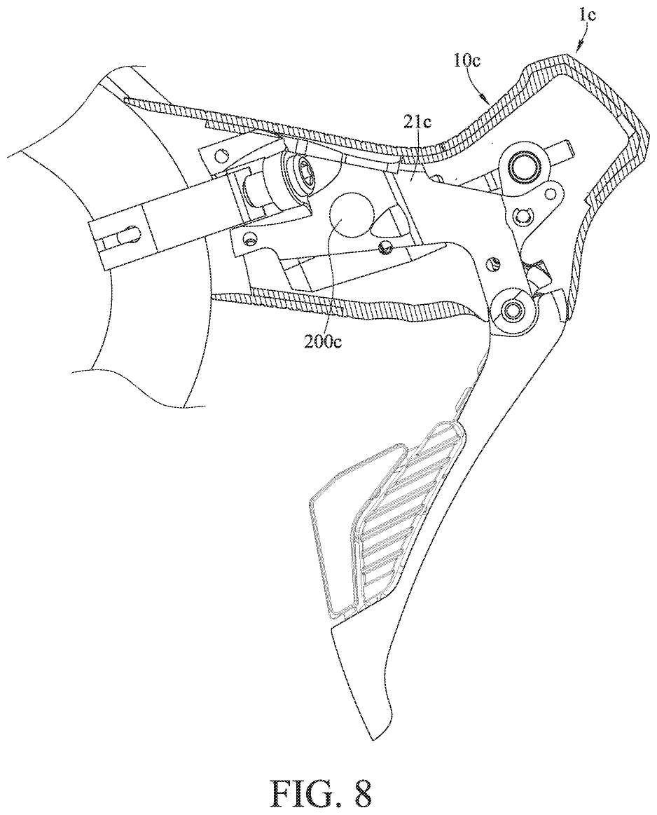

As shown in FIG. 8, a battery 200c is disposed in a casing 10c of a bicycle brake lever 1c and located aside a main body 21c of the bicycle brake lever 1c. From the view of FIG. 8, the battery 200c is located at a side of the main body 21c close to the viewer; but the disclosure is not limited thereto; in some other embodiments, the battery may be located at a side of the main body away from the viewer.

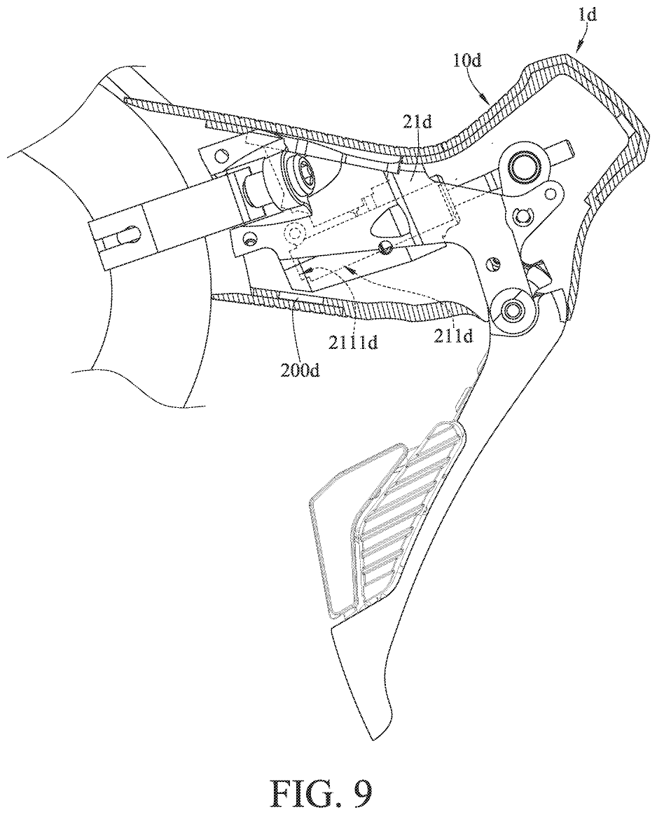

As shown in FIG. 9, a battery 200d is disposed in a casing 10d of a bicycle brake lever 1d and located below a main body 21d of the bicycle brake lever 1d. In specific, the battery 200d is located below an inner bottom surface 2111d of a hydraulic chamber 211d of the main body 21d.

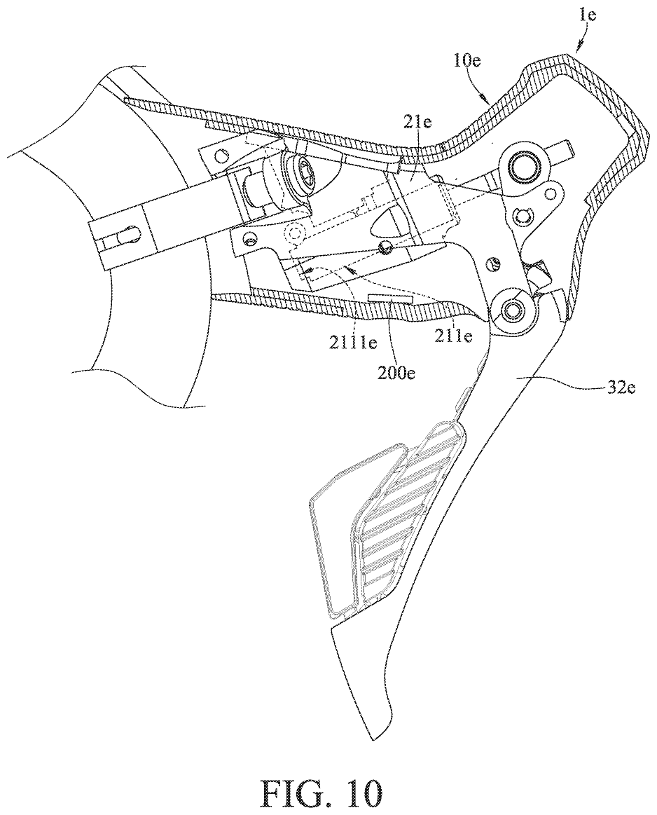

As shown in FIG. 10, a battery 200e is disposed in a casing 10e of a bicycle brake lever 1e and located below a main body 21e of the bicycle brake lever 1e. The battery 200e is located closer to a lever 32e than an inner bottom surface 2111e of a hydraulic chamber 211e of the main body 21e, but the disclosure is not limited thereto; in some other embodiments, the battery may be located farther away from the lever 32e than the inner bottom surface 2111e of the hydraulic chamber 211e of the main body 21e.

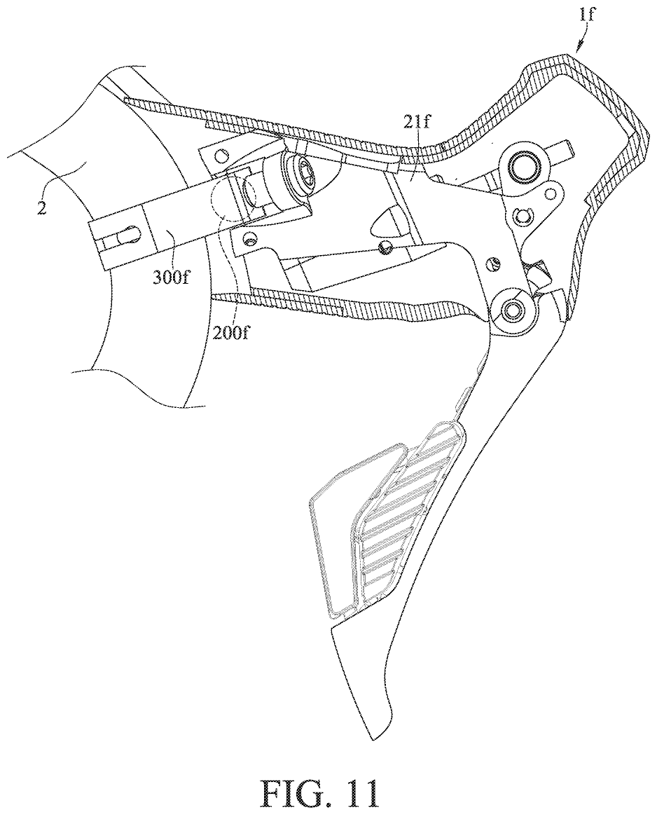

As shown in FIG. 11, a bicycle brake lever 1f may include a fastener 300f connected to a main body 21f of the bicycle brake lever 1f. The bicycle brake lever 1f is mounted on the handlebar 2 via the fastener 300f. A battery 200f is disposed on the fastener 300f.

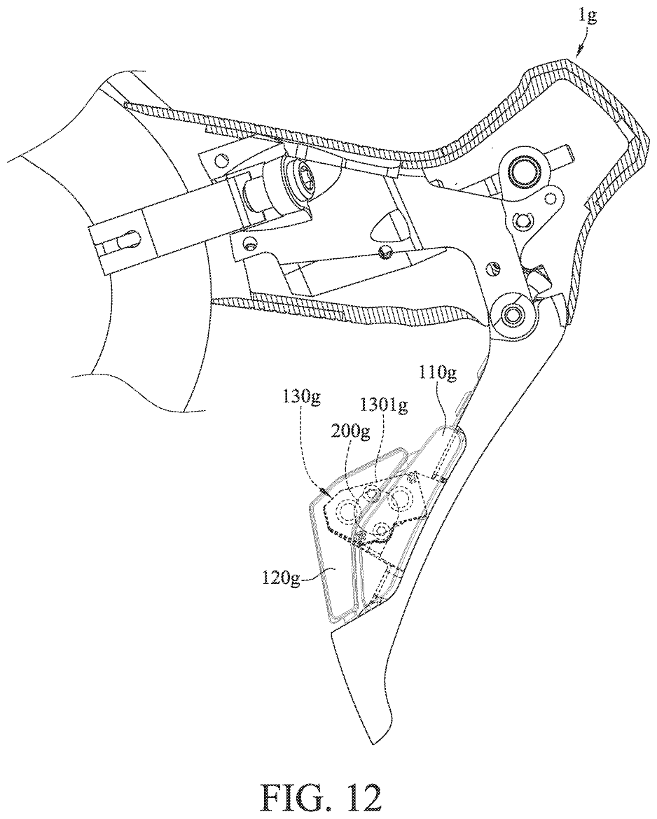

As shown in FIG. 12, a battery 200g is disposed on a base 1301g of a signal generator 130g of a bicycle brake lever 1g. In this or another embodiment, the battery 200g may be located at a side of the base 1301f away from a first shift lever 110g and a second shift lever 120g of the bicycle brake lever 1g.

According to the bicycle brake levers as discussed in the above embodiments, the pivotable component connects the link with the lever, and the first end portion and the second end portion of the pivotable component, located opposite to each other, are respectively and pivotably disposed on the link and the lever, such that the part of the link being pivotably connected to the pivotable component (i.e., the area adjacent to the second pivot) is located above the part of the lever being pivotably connected to the main body (i.e., the area adjacent to the third pivot) while having the bicycle brake lever being a push-type brake lever. This arrangement of the bicycle brake lever prevents pinching fingers when pushing the lever.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A bicycle brake lever, adapted to be mounted on a handlebar, comprising:
a casing;
a hydraulic assembly, disposed in the casing, wherein the hydraulic assembly comprises a main body, a piston, and a link, the piston is movably located in the main body, and the link is connected to the piston; and
a driving assembly, comprising:
a pivotable component, having a mount portion, a first end portion, and a second end portion, wherein the mount portion is located between and connected to the first end portion and the second end portion, the mount portion is pivotably disposed on the main body, and the first end portion of the pivotable component is pivotably disposed on the link; and
a lever, pivotably disposed on the main body, wherein the second end portion of the pivotable component is pivotably disposed on the lever;
wherein when the lever is pivoted relative to the main body, the lever moves the piston via the pivotable component and the link so as to increase an oil pressure in the main body.

2. The bicycle brake lever according to claim 1, further comprising a first pivot, a second pivot, a third pivot, and a fourth pivot, wherein the mount portion of the pivotable component is pivotably disposed on the main body via the first pivot, the first end portion of the pivotable component is pivotably disposed on the link via the second pivot, the lever is pivotably disposed on the main body via the third pivot, the second end portion of the pivotable component is pivotably disposed on the lever via the fourth pivot, the first pivot, the second pivot, the third pivot, and the fourth pivot are arranged along a line substantially parallel to a longitudinal axis of the lever, and the first pivot and the fourth pivot are located between the second pivot and the third pivot.

3. The bicycle brake lever according to claim 2, wherein the lever has at least one oval hole, the second end portion of the pivotable component has a mount hole, the fourth pivot is disposed through the at least one oval hole and the mount hole, and the fourth pivot is movably located in the at least one oval hole.

4. The bicycle brake lever according to claim 1, wherein the main body has an oil outlet, and the piston is located between the oil outlet and the link.

5. The bicycle brake lever according to claim 4, wherein the main body has an oil storage space, a hydraulic chamber, and an oil outlet channel, the piston is movably located in the hydraulic chamber, the oil storage space is in fluid communication with the hydraulic chamber, the oil outlet channel is in fluid communication with the hydraulic chamber via the oil outlet, and the oil outlet channel is located between the oil storage space and the hydraulic chamber.

6. The bicycle brake lever according to claim 1, further comprising an elastic component and an adjustment component, wherein the lever comprises an operating part and a transmission part, an end of the operating part and an end of the transmission part are together pivotably disposed on the main body, another end of the transmission part is pivotably disposed on the pivotable component, two opposite ends of the elastic component respectively press against the operating part and the transmission part, the elastic component is configured to force the operating part to pivot relative to the transmission part along a pivoting direction, the adjustment component is in contact with the operating part and is movable to force the operating part to pivot relative to the transmission part along a direction opposite to the pivoting direction to adjust a position of the operating part relative to the transmission part.

7. The bicycle brake lever according to claim 6, wherein the transmission part has a protrusion, the operating part has a recess, the elastic component is partially located in the recess, and the two opposite ends of the elastic component respectively press against the protrusion of the transmission part and an inner bottom surface of the recess.

8. The bicycle brake lever according to claim 7, wherein the transmission part has a through hole and a recess connected to each other, the through hole is located at the protrusion of the transmission part, the operating part has a protrusion, the protrusion of the operating part is movably mounted in the recess, and the adjustment component is movably located in the through hole and in contact with the protrusion of the operating part.

9. The bicycle brake lever according to claim 1, wherein the main body has a hydraulic chamber, an oil inlet, and an oil outlet, the oil inlet and the oil outlet are in fluid communication with the hydraulic chamber, the oil inlet is located farther away from an inner bottom surface of the hydraulic chamber than the oil outlet, the piston is movably located in the hydraulic chamber; when the lever is pivoted relative to the main body, the lever moves the piston towards the inner bottom surface of the hydraulic chamber via the pivotable component and the link so as to increase the oil pressure in the hydraulic chamber of the main body.

10. A bicycle brake lever, adapted to be mounted on a handlebar, comprising:
a casing;
a hydraulic assembly, disposed in the casing;
a driving assembly, configured to drive the hydraulic assembly, wherein the driving assembly comprises a lever, the lever comprises an operating part and a transmission part, and the operating part is pivotably disposed on the transmission part;
an elastic component, wherein two opposite ends of the elastic component respectively press against the operating part and the transmission part, and the elastic component is configured to force the operating part to pivot relative to the transmission part along a pivoting direction; and
an adjustment component, in contact with the operating part, wherein the adjustment component is movable to force the operating part to pivot relative to the transmission part along a direction opposite to the pivoting direction to adjust a position of the operating part relative to the transmission part.
